(19) United States
(12) Patent Application Publication
(10) Pub. No.: US 2003/0042644 A1
(43) Pub. Date: Mar. 6, 2003

(54) Extruded, polystyrene-based resin foam plate and method for the production thereof

(75) Inventors: Hiroyuki Gokuraku, Imaichi-shi (JP); Naochika Kogure, Utsunomiya-shi (JP); Seiji Takahashi, Saitama-shi (JP); Daisuke Imanari, Toshigi-ken (JP); Masato Naito, Kanuma-shi (JP)

Correspondence Address: LORUSSO & LOUD, 3137 Mt. Vernon Avenue, Alexandria, VA, 22305, US

(73) Assignee: JSP CORPORATION

(21) Appl. No.: 10/170,725

(22) Filed: Jun. 14, 2002

(30) Foreign Application Priority Data
Jun. 18, 2001 (JP) 2001-183249

(51) Int. Cl. B29C 44/00; B32B 3/26

(52) U.S. Cl. 264/55; 428/304.4

(57) ABSTRACT

An extruded, polystyrene-based resin foam plate produced by extruding a foamable molten composition containing a polystyrene-based resin and a blowing agent consisting of (a) isobutane and (b) a blowing agent component other than isobutane, chlorofluorocarbons and fluorocarbons from a high pressure zone into a lower pressure zone. The extruded foam plate has a thickness of at least 10 mm and an apparent density of 25-60 kg/m³ contains residual isobutane in an amount of 0.45-0.80 mol per 1 kg thereof, has cells having an average diameter in the thickness direction thereof of 0.05-0.18 mm and a cell strain rate of 0.7-1.2, wherein the cell strain rate is obtained by dividing the average diameter in the thickness direction of the extruded foam plate by the average diameter in the horizontal direction of the extruded foam plate, meets the flammability standard on extruded polystyrene foam insulation plates as defined in JIS A9511-1995, and has a thermal conductivity of not greater than 0.028 W/m·K.

### BACKGROUND OF THE INVENTION

The present invention relates to an extruded, polystyrene-based resin foam plate for use as a heat insulator for walls, floors, roofs and so on of buildings or as a tatami mat core, and to a method for production thereof.

Because polystyrene-based resin foams have excellent heat insulating property and desirable mechanical strengths, plates thereof have been widely used as heat insulators. One known method for production of such a foam plate comprises the steps of heating and kneading a polystyrene-based resin material together with a nucleating agent, mixing the kneaded mixture with a physical blowing agent, and extruding the mixture from a high pressure zone into a lower pressure zone.

As the blowing agent for use in the production of the foam plate, a chlorofluorohydrocarbon (which will be hereinafter referred to as “CFC”) such as dichlorodifluoromethane have been hitherto widely used. However, in place of CFCs having a possibility of destroying the ozone layer, a hydrogen atom-containing chlorofluorohydrocarbon (which will be hereinafter referred to as “HCFC”), which has a smaller ozone destroy coefficient, is increasingly used in recent years.

However, HCFCs, whose ozone destroy coefficient is not 0, are not without possibility of destroying the ozone layer. Thus, it has been studied to use a fluorohydrocarbon (which will be hereinafter referred to as “HFC”) having an ozone destroy coefficient of 0 and containing no chlorine atom in the molecules thereof as the blowing agent.

However, HFCs have a large global warming coefficient and thus still have a room to be improved in view of the preservation of the global environment.

Thus, it is desired to produce a polystyrene-based resin foam plate using a blowing agent having an ozone destroy coefficient of 0 and a small global warming coefficient.

Isobutane, which has an ozone destroy coefficient of 0 and a small global warming coefficient, is an excellent blowing agent. Also, since isobutane has a permeation rate to polystyrene which is much lower than that of air, a foamed heat insulation plate produced using isobutane can maintain the heat insulating property at the time of production over a long period of time. However, since isobutane in a gas phase has a thermal conductivity which is lower than that of air but higher than that of CFCs, HCFCs or HFCs which have been heretofore used, it is difficult to obtain a heat insulating property comparable to that given by HFCs and so on by using isobutane as a blowing agent. Also, since isobutane has a high flammability itself, it is considerably difficult to impart flame retardancy to the resulting foam.

### SUMMARY OF THE INVENTION

The present invention has been made in view of the drawbacks of the conventional polystyrene resin extruded foam plate.

It is, therefore, an object of the present invention to provide an extruded, polystyrene-based resin foam plate which is produced using isobutane having an ozone destroy coefficient of 0 and a small global warming coefficient as a blowing agent, and which has excellent flame retardancy and low thermal conductivity.

In accordance with one aspect of the present invention, there is provided an extruded, polystyrene-based resin foam plate produced by extruding a foamable molten composition containing a polystyrene-based resin and a blowing agent comprising (a) isobutane and (b) a blowing agent component other than isobutane, chlorofluorocarbons and fluorocarbons from a high pressure zone into a lower pressure zone, said extruded foam plate

having a thickness of at least 10 mm and an apparent density of 25-60 kg/m³,

containing residual isobutane in an amount of 0.45-0.80 mol per 1 kg thereof,

having cells having an average diameter in the thickness direction thereof of 0.05-0.18 mm and a cell strain rate of 0.7-1.2, wherein the cell strain rate is obtained by dividing the average diameter in the thickness direction of the extruded foam plate by the average diameter in the horizontal direction of the extruded foam plate,

meeting the flammability standard on extruded polystyrene foam insulation plates as defined in JIS A9511-1995, and

having a thermal conductivity of not greater than 0.028 W/m·K.

In another aspect, the present invention provides a method for the production of an extruded polystyrene-based resin foam plate, comprising the steps of;

(a) kneading a raw material composition comprising a molten polystyrene-based resin, a blowing agent consisting of 90-50 mol % of isobutane and a balance of a blowing agent component other than isobutane, chlorofluorocarbons and fluorocarbons, and a flame retardant in an extruder to obtain a foamable molten composition;

(b) continuously extruding said foamable molten composition from a high pressure zone into a lower pressure zone through a die;

(c) passing said extruded foamable molten composition, while it is foaming, through a passage which is defined by upper, lower, right and left walls and which is connected to said die, wherein the distance between said upper and lower walls is once enlarged and then narrowed from the entrance toward the exit to compress said foamable molten composition during its passage through said passage; and

(d) then passing said compressed foamable molten composition through a shaping device, in which said compressed foamable molten composition is allowed to expand in at least thickness and width directions thereof with at least the expansion in the thickness direction being restrained by said shaping device, thereby to obtain the extruded foam plate,

wherein said passage meeting the following conditions (1) to (3):

W/b≧1.08 (1)

T/h≧1.20 (2)

(W/b)/(T/h)≧0.90 (3)

wherein T and W are the thickness (mm) and width (mm), respectively, of the extruded polystyrene-based foam plate obtained, and h and b are the height h (mm) and width b (mm), respectively, of that part of said passage at which the cross-sectional area of said passage is smallest in the downstream of that part of said passage at which the cross-sectional area of said passage is largest.

### BRIEF DESCRIPTION OF THE DRAWINGS

Other objects, features and advantages of the present invention will become apparent from the detailed description of the preferred embodiments of the invention which follows, when considered in the light of the accompanying drawing, in which

FIG. 1 is a cross-sectional view schematically illustrating an embodiment of a die and a shaping device of a plate forming apparatus useful for carrying out a method for the production of an extruded foam plate according to the present invention.

### DETAILED DESCRIPTION OF THE PREFERRED EMBODIMENTS OF THE INVENTION

The extruded polystyrene-based foam plate according to the present invention (which will be hereinafter referred to as “extruded foam plate”) is obtained by extruding a foamable molten composition containing a polystyrene-based resin and a blowing agent from a high pressure zone into a lower pressure zone. More particularly, the extruded foam plate of the present invention is produced by heating and kneading the polystyrene-based resin and one or more additives such as a flame retardant and a nucleating agent in an extruder to obtain a molten resin mixture. The blowing agent consisting of (a) isobutane and (b) a blowing agent component other than isobutane, chlorofluorocarbons and fluorocarbons is mixed and kneaded with the molten resin mixture under a high pressure to obtain a foamable molten composition. While adjusting the foamable molten composition to a temperature suitable for foaming and extruding, the foamable molten composition is extruded from a high pressure zone to a lower pressure zone through a die. The thus produced extruded foam plate has a large thickness, a low apparent density and high dimensional stability and is friendly to global environment.

Suitable examples of the polystyrene-based resin for use in the present invention include styrene homopolymers and copolymers mainly composed of styrene such as a styrene-acrylic acid copolymer, a styrene-methacrylic acid copolymer, a styrene-maleic anhydride copolymer, a styrene-butadiene copolymer, a styrene-acrylonitrile copolymer, an acrylonitrile-butadiene-styrene terpolymer and high-impact polystyrene. These hompolymers and copolymers may be used alone or in combination of two or more thereof. The styrene-based copolymers preferably comprise styrene monomeric units of at least 50 mol %, more preferably at least 80 mol %.

The polystyrene-based resin for use in the present invention preferably has a melt flow rate (MFR) in the range of 0.5-30 g/10 min (as measured according to JIS K7210 (1976), Test Condition 8 of Method A). More preferable is the use of a polystyrene-based resin having a melt flow rate in the range of 1-10 g/10 min because excellent extrusion moldability can be obtained in producing the extruded foam plate and because the resulting extruded foam plate can have high mechanical strengths.

If desired, the polystyrene-based resin may be used as a mixture with another polymer or copolymer such as a polyolefin resin or a styrene-based elastomer as long as the object and effect of the present invention is not adversely affected. The amount of such another polymer or copolymer is not more than 30 parts by weight, preferably not more than 10 parts by weight, per 100 parts by weight of the polystyrene-based resin.

The extruded foam plate of the present invention is produced using a blowing agent consisting of isobutane and a blowing agent component other than isobutane, chlorofluorocarbons and fluorocarbons. Thus, neither chlorofluorocarbons nor fluorocarbons are contained in the blowing agent. As a consequence, the blowing agent contained in the extruded foam plate of the present invention has an ozone destroy coefficient of 0 and a small global warming coefficient and thus is friendly to the global environment. Also, since isobutane has a permeation rate to polystyrene which is much lower than that of air, a foamed heat insulation plate produced using isobutane can maintain the heat insulating property at the time of production over a long period of time.

It is important that the extruded foam plate of the present invention contain residual isobutane in an amount of 0.45-0.80 mol per 1 kg of the extruded foam plate. When the residual amount of isobutane is less than 0.45 mol, high heat insulating property required in a heat insulating material for construction use cannot be obtained. In particular, there is a possibility of failing to obtain an extruded foam plate having a thermal conductivity as specified in JIS A9511-1995 for Type 3 extruded polystyrene foam insulation plate (not greater than 0.028 W/m·K). When the residual amount of isobutane is over 80 mol, flame retardancy required to a material for construction use cannot be obtained. In particular, there is a possibility of failing to meet the flammability standard on Type 3 extruded polystyrene foam insulation plate provided in JIS A9511-1995. The residual amount of isobutane in the extruded foam plate of the present invention is preferably greater than 0.56 mol but not greater than 0.76 mol per 1 kg thereof.

Isobutane is used in conjunction with an additional blowing agent component. Any known blowing agent may be used as the additional blowing agent as long as it is not a chlorofluorocarbon or a fluorocarbon. The additional blowing agent is suitably selected from the group consisting of alkyl chlorides, such as methyl chloride and ethyl chloride, carbon dioxide, dimethyl ether, diethyl ether, methyl ethyl ether and mixtures thereof. These additional other blowing agents, which have a high foaming property, have an effect of lowering the apparent density of the resulting extruded foam plate. Also, these additional blowing agents are allowed to escape from the extruded foam plate in a short time because of their high gas permeability to polystyrene and, thus, are effective to stabilize the heat insulating property and flame retardancy of the extruded foam plate in a short time. Especially preferred is the use of carbon dioxide because carbon dioxide has an effect of making the cells in the resulting extruded foam plate small and thus enables to reduce the amount of the nucleating agent to be added.

On the other hand, isobutane is allowed to escape only slightly from the extruded foam plate. Thus, isobutane hardly decreases even if the extruded foam plate is allowed to stand at room temperature for 5 years after production and, hence, the high heat insulating property of the extruded foam plate can be maintained. The use of aliphatic hydrocarbons other than isobutane such as propane and n-butane as the additional blowing agents is not very preferable. Aliphatic hydrocarbons other than isobutane take relatively long time to escape from an extruded foam plate and, when used in a large amount, may largely reduce the heat insulating property of the extruded foam plate in a short time. However, it is possible to use aliphatic hydrocarbons other than isobutane in a small amount that will not inhibit the purpose of the present invention. When used as the additional blowing agent, aliphatic hydrocarbons other than isobutane are preferably used in an amount of not greater than 5 mol %, more preferably not greater than 3 mol %, and most preferably not greater than 1 mol %, based on a total of the blowing agents.

The residual amount of the blowing agent herein is measured by gas chromatography as follows. A sample piece cut off from a center part of an extruded foam plate is put in a sample bottle with a lid, in which toluene is contained. After closing the lid, the bottle is sufficiently shaken so that the blowing agents in the sample piece may be dissolved in the toluene, thereby obtaining a measuring sample liquid. By performing gas chromatography on the sample liquid, the residual amounts of isobutane, an alkyl chloride, etc. in the extruded foam plate are determined.

The measuring conditions of the gas chromatography are as follows.

Column:

Manufacturer: Shinwa Chemical industries, Ltd.

Support: Chromosorb W, 60-80 mesh, AW-DMCS treated

Liquid phase: Silicone DC 550 (liquid phase quantity: 20%)

Column size: 4.1 m in length, 3.2 mm in inside diameter

Column material: glass

Packed column baking conditions: 220° C., 40 hours

Column temperature: 40° C.

Inlet temperature: 200° C.

Carrier gas: nitrogen

Carrier gas velocity: 3.5 ml/min

Detector: FID

Detector temperature: 200° C.

Determination: internal standard method

It is important that the extruded foam plate of the present invention should have an apparent density of 25-60 kg/m³. An extruded foam plate having an apparent density of less than 25 kg/m³, which is itself difficult to produce, is poor in mechanical physical properties as compared with a conventional foam insulation plate and thus has limited application. Also, an extruded foam plate having an apparent density of less than the above range is poor in flame retardancy. An extruded foam plate having an apparent density of over 60 kg/m cannot exhibit a sufficient heat insulating property unless it has a thickness greater than necessary and may have a disadvantage in lightness in weight. The extruded foam plate of the present invention preferably has an apparent density in the range of 36-60 kg/m³. When the apparent density of the extruded foam plate is in this range, it is easy to impart a high heat insulating property thereto and, additionally, a high flame retardancy can be obtained when hexabromocyclododecane, which has been conventionally used in foam plates of this type, is used as a flame retardant even in a small amount.

It is also important that the extruded foam plate of the present invention should meet the flammability standard on extruded polystyrene foam insulation plates provided in JIS A9511-1995. Namely, when a flammability test is conducted on the extruded foam plate according to Measuring method A in Section 4.13.1 of JIS A9511-1995, the fire goes out on its own in 3 seconds without leaving residue and does not burn beyond a burning limit line. Such an extruded foam plate, which has a low possibility of burning up even if it catches fire, meets with the safety requirements for an extruded polystyrene foam insulating material for construction use.

The extruded foam plate of the present invention preferably should have a thermal conductivity of not greater than 0.028 W/m·K, which meets the thermal conductivity standard on Type 3 extruded polystyrene foam insulation plate provided in JIS A9511-1995, and thus is suitable for heat insulation plate for construction use. The thermal conductivity is measured according to a plate type heat flow meter method (a twin-plate type, average temperature: 20° C.) provided in JIS A1412-1994. The extruded foam plate of the present invention should have a thickness of at least 10 mm, preferably 15-200 mm, more preferably 20-150 mm.

It is also important that the extruded foam plate of the present invention should have cells having an average diameter in the thickness direction of the plate of 0.05-0.18 mm. When the average cell diameter is less than 0.05 mm, there is a possibility that, in producing the extruded foam plate, the molten resin mixture which has been extruded though a die lip and has foamed cannot be formed into a plate shape by a shaping device. When the average cell diameter is over 0.18 mm, there is a possibility of failing to obtain a targeted heat insulating property. In view of the above, the extruded foam plate of the present invention preferably has cells having an average diameter in the thickness direction of the plate in the range of 0.07-0.15 mm, more preferably in the range of 0.08-0.14 mm.

The average cell diameter herein is measured as follows.

An area randomly selected at a center part of a vertical cross-section of the extruded foam plate taken in the width direction (a lateral direction perpendicular to the extrusion (longitudinal) direction) thereof is magnified 200 times by a microscope. On the screen of the microscope or a microphotograph of the area, 20 cells are randomly selected from cells whose whole shape can be observed (excluding cells a part of which is not observed because located at edges of the screen or the microphotograph and cells communicated with adjacent cells due to a lack of a part of the cell wall). When there are less than 20 cells whose whole shape can be observed, cells in another view or another microphotograph of a different area in the same cross-section may be additionally used. Then, each of the selected cells is circumscribed by a rectangle or a square such that a pair of opposite sides and the other pair of opposite sides of the rectangle or square extend in the thickness direction and the width direction, respectively, of the foam plate. The thus obtained 20 rectangles or squares are measured for the length of a side extending in the thickness direction of the foam plate and the length of a side extending in the width direction of the foam plate. The arithmetic mean for each direction is calculated, thereby obtaining an average cell diameter in the thickness direction of the foam plate (D_{T}: mm) and an average cell diameter in the width direction of the foam plate (D_{W}: mm). Similar measurements are repeated three times in total at different cross-sections. The average cell diameters D_{T} and D_{W} are each the arithmetic mean of measurements in different three cross-sections.

An average cell diameter in the extrusion direction of the foam plate (D_{L}: mm) is obtained in the same manner as that of D_{W} except that an area randomly selected at a center part of a vertical cross-section of the extruded foam plate taken in the extrusion direction is used and that rectangles or squares are drawn such that a pair of sides thereof extend in the extrusion direction of the foam plate. Similar measurements are repeated three times in total at different cross-sections. The average cell diameter D_{L} is the arithmetic mean of measurements in different three cross-sections.

An average cell diameter in the horizontal direction of the foam plate (D_{H}: mm) is the arithmetic mean of D_{W} and D_{L}.

The extruded foam plate of the present invention should have a cell strain rate in the range of 0.7-1.2. The cell strain rate is a value obtained by dividing D_{T} by D_{H} (D_{T}/D_{H}) obtained as above. The smaller the cell strain rate is, the flatter the cells are. The larger the cell strain rate is, the longer vertically the cells are. When the cell strain rate is less than 0.7, the cells are so flat that the compressive strength of the extruded foam plate in the thickness direction may be poor. Also, flat cells have so strong a tendency to return to a spherical shape that the dimensional stability of the foam plate may be poor. When the cell strain rate is over 1.2, the number of cells in the thickness direction of the foam plate is so small that there is a possibility of failing to obtain a targeted heat insulating property. In view of the above, the cell strain rate is preferably in the range of 0.80-1.15, more preferably in the range of 0.85-1.10.

The extruded foam plate of the present invention preferably has cells of substantially the same size as a whole. It is possible to allow cells of large and small sizes to mingle in the extruded foam plate, as disclosed in Japanese Examined Patent Publication No. H05-49701. However, an extruded foam plate having cells of substantially the same size as a whole is preferable because it is better in uniformity of mechanical properties.

The extruded foam plate of the present invention preferably contains hexabromocyclododecane in an amount of at least 2 parts by weight per 100 parts of the polystyrene-based resin for reasons of easiness to meet the flammability standard on Type 3 extruded polystyrene foam insulation plate provided in JIS A9511-1995 and of inhibition of formation of cells at the time of extrusion foaming. Hexabromocyclododecane is a flame retardant generally used in foam plates of this type. The present invention can be accomplished with the use of such a general flame retardant and, it is possible to impart high flame retardancy to the extruded foam plate without using a special flame retardant (for example, phosphorus-containing flame retardants such as ammonium phosphate and ammonium polyphosphate).

Description will be next made of the method for the production of the extruded foam plate of the present invention.

The polystyrene-based resin and the additives including the flame retardant are heated and kneaded in an extruder. With the addition of the blowing agent composed of isobutane preferably in an amount of 90-50 mol % and one or more additional blowing agent components (other than isobutane, chlorofluorocarbons and fluorocarbon) preferably in an amount of 10-50 mol %, the kneaded mixture is further kneaded under application of heat to obtain a foamable molten composition.

The additives other than the flame retardant include, for example, a nucleating agent. The nucleating agent is added for the purpose of controlling the average diameter of the cells in the extruded foam plate. Suitable nucleating agent is inorganic particles such as particles of talc, kaolin, mica, silica, calcium carbonate, barium sulfate, titanium oxide, clay, aluminum oxide, bentonite, or diatom earth. These inorganic particles may be used alone or in combination. Among the above examples, talc particles are preferably employed for reasons of allowing formation of cells having a small diameter and not inhibiting the flame retardancy of the extruded foam plate. Especially preferable is the use of talc particles having a small diameter of 0.1-10 μm, more preferably 0.5-5 μm.

When used as the nucleating agent, talc particles are added in an amount of 1-10 parts by weight, preferably 2-8 parts by weight, per 100 pars by weight of the polystyrene-based resin.

Other additives such as a colorant, a thermal stabilizer and a filler may be used in addition to the nucleating agent and the flame retardant, as desired, to the extent that will not inhibit the purpose of the present invention.

As described previously, the blowing agent is preferably composed of 90-50 mol % of isobutane and 10-50 mol % of one or more additional blowing agent components other than chlorofluorocarbons and fluorocarbons. When a blowing agent having an isobutane content outside the above range is used, there is a possibility of failing to obtain an extruded foam plate containing residual isobutane in an amount in the range of 0.45-0.80 mol per 1 kg of the extruded foam plate.

Since the blowing agent does not contain chlorofluorocarbons and fluorocarbons, the extruded foam plate produced by the method of the present invention, which has an ozone destroy coefficient of 0 and a small global warming coefficient, is friendly to the global environment. Also, isobutane has a permeation rate to polystyrene which is much lower than that of air, so that the extruded foam plate produced according to the present invention can maintain the heat insulating property at the time of production over a long period of time.

In the method of the present invention, the foamable molten composition is, after having been adjusted to a temperature suitable for foaming, continuously extruded from a high pressure zone to a lower pressure zone through a die lip and shaped into a plate shape while it is foaming. More specifically, the foamable molten composition is passed, while it is foaming, through a passage having a specific structure to compress the foamable resin mixture in the process of foaming and then formed into a plate shape by passing through a shaping device.

The temperature suitable for foaming is in the range in which the foamable molten composition exhibits a viscosity suitable for foaming. The suitable temperature varies depending upon the type of the polystyrene-based resin used, presence or absence of a fluidity improver (when used, the type and amount thereof), and the amount and composition of the blowing agent. In a case where polystyrene homopolymer is used as the polystyrene-based resin, for example, the suitable foaming temperature is generally 110-130° C.

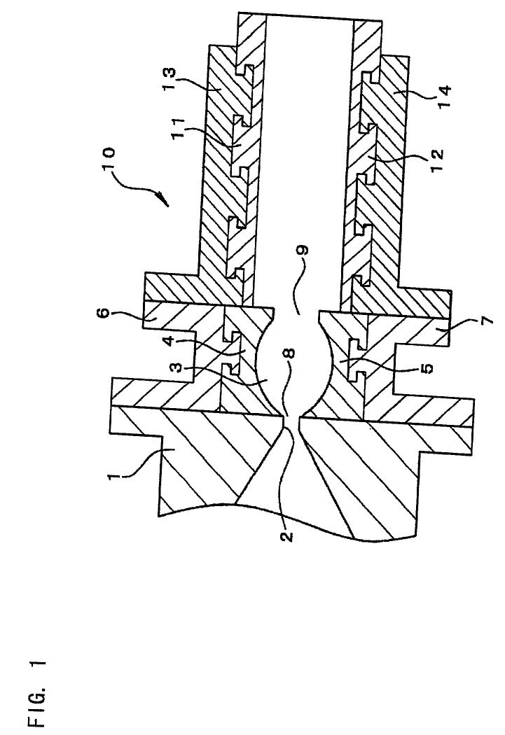

An example of the passage and shaping device having a specific structure mentioned before for use in the method of the present invention is shown in FIG. 1.

FIG. 1 is a partial view of an embodiment of a plate forming apparatus having a die, a passage having a specific structure, and a shaping device. In FIG. 1, designated as 1 is a die, as 2 is a die lip, as 3 is a passage having a specific structure, as 4 is an upper wall, as 5 is a lower wall, as 6 is a support plate of the upper wall 4, as 7 is a support plate of the lower wall 5, as 8 is an entrance of the passage, as 9 is an exit of the passage, as 10 is a shaping device, as 11 an upper parallel plate of the shaping device, as 12 is a lower parallel plate of the shaping device, as 13 is a support plate of the upper parallel plate 11 and as 14 is the support plate of the lower parallel plate 12.

The passage 3 is defined by upper, lower, right and left walls which are connected to the die 1. In the passage 3, at least the distance between the upper and lower walls is once enlarged and then narrowed from the entrance toward the exit thereof. Namely, the passage 3 is defined by the upper wall 4, lower wall 5 and right and left walls (the right and left walls are not shown), and has the entrance 8 and the exit 9, the entrance 8 being in tight contact with the die 1. The passage 3 is constructed such that at least the distance between the upper and lower walls 4 and 5 is once enlarged and then narrowed toward the exit 9.

The distance between the right and left walls of the passage 3 may be also once enlarged toward the exit 9 or narrowed toward the exit 9, if desired.

The foamable molten composition extruded through the die lip 2 starts foaming in the passage 3 immediately after the extrusion. Thus, by withdrawing the foamable molten composition at a rate corresponding to the extrusion rate thereof, the foamable molten composition can be compressed in the passage 3 while it is foaming. Namely, since at least the distance between the upper and lower walls 3 is once enlarged and then narrowed from the entrance 8 toward the exit 9 in the passage 3, the foamable molten composition is allowed to foam relatively freely at the part of the passage 3 enlarged toward the exit 9 and compressed while it is still foaming at the part narrowed toward the exit 9, especially at the exit 9.

Interior walls of the passage 3, such as the upper wall 4 and the lower wall 5, are preferably made of a material on which the foamable molten composition can flow smoothly, for example, a fluorine-containing resin such as a polytetrafluoroethylene resin.

In the method of the present invention, after having been passed through the passage 3, the foamable molten composition, which is still in the process of foaming, is then passed through the shaping device 10 and formed into an extruded foam plate having a plate shape. Namely, the foamable molten composition withdrawn from the exit 9 of the passage 3 is allowed to foam further in the shaping device 10 having the two parallel plates 11 and 12 and to fill the gap therebetween, whereby the foamable molten composition is formed into the extruded foam plate having a plate shape.

In forming the extruded foam plate in the shaping device 10, the withdrawal rate of the foamable molten composition is suitably adjusted to allow the foamable molten composition still in the process of foaming to expand at least in the thickness and lateral directions thereof while it is passing through the shaping device 10 and to fill the gap between the upper and the lower parallel plates 11 and 12. Thereby, the foamable molten composition may be formed into the extruded foam plate having a plate shape with its expansion at least in the thickness direction restrained. Meant by “to allow the foamable molten composition to expand at least in the thickness and lateral directions” is that the foamable molten composition may be allowed to additionally expand in the extrusion direction thereof depending upon the balance between the extrusion rate and the withdrawal rate thereof.

When the foamable molten composition in the process of foaming expands to reach the side parallel walls of the shaping device 10, further expansion of the foamable molten composition in the lateral direction is restricted by the side walls.

The shaping device 10 of the plate forming apparatus comprises at least upper and lower parallel plates 11 and 12. Meant by “comprises at least upper and lower parallel plates” is that the shaping device may be further provided with parallel plates on both sides thereof. When the shaping device 10 of the plate forming apparatus has only upper and lower parallel plates 11 and 12, both sides thereof are opened to the air. The material of the parallel plates is not specifically limited. However, for the purpose of decreasing friction resistance with the foamable molten composition to smooth the surfaces of the resulting extruded foam plate, the use of plates of a fluorine-containing resin such as polytetrafluoroethylene is preferred.

In the method of the present invention, the foamable molten composition is compressed in the passage 3 such that the following conditions (1) to (3) are fulfilled:

W/b≧1.08 (1)

T/h≧1.20 (2)

(W/b)/(T/h)≧0.90 (3)

wherein T and W are the thickness (mm) and width (mm), respectively, of the extruded foam plate obtained, and h and b are the height (mm) and width (mm), respectively of the part of the passage 3 at which the cross-sectional area of the passage 3 is smallest in the downstream of that part of the passage at which the cross-sectional area is largest. That part of the passage 3 at which the cross-sectional area is smallest in the downstream of the part of the passage 3 at which the cross-sectional area is largest is usually the exit 9 of the passage 3 or a parallel section of the passage 3 continuing from the exit 9.

In order to satisfy the conditions (1) and (2) simultaneously, it is necessary to pass the foamable molten composition in the process of foaming through that part of the passage 3 at which the cross-sectional area of the passage 3 is smallest while it still has strong foamability, not long after having been extruded through the die lip. When the foamable molten composition is passed through that part of the passage 3 at which the cross-sectional area of the passsage 3 is smallest after the foamability thereof has considerably lowered (W/b will be lower than 1.08 or/and T/h will be lower than 1.20), the cell diameter in the thickness direction of the foam plate cannot be made small, resulting in difficulty in maintaining the cell strain rate not greater than 1.2 and possibility of failing to impart a high heat insulating property to the extruded foam plate.

Also, when W/b is equal to or smaller than T/h, the cell diameter in the thickness direction of the foam plate cannot be made small, resulting in difficulty in maintaining the cell strain rate not greater than 1.2 and possibility of failing to impart a high heat insulating property to the extruded foam plate.

In order to obtain a foam plate having a cell strain rate in the range of 0.7-1.2 with ease, the foamable molten composition is preferably compressed such that W/b, T/h and (W/b)/(T/h) satisfy the following conditions (4) to (6), respectively.

3.0≧W/b≧1.20 (4)

2.0≧T/h≧1.30 (5)

2.0≧(W/b)/(T/h)≧0.92 (6)

As above, compressing the foamable molten composition in the process of foaming in the passage 3 is the best way to obtain a foam plate having a cell strain rate in the range mentioned before.

According to the above-mentioned method of the present invention, the extruded foam plate can be produced with ease. The thus obtained extruded foam plate preferably has a closed cell content of at least 80%, more preferably at least 85%, and most preferably at least 90%. The higher the closed cell content is, the better the extruded foam plate can maintain the heat insulating property. The closed cell content of the extruded foam plate is obtained according to Procedure C of ASTM D-2856-70 as follows. The true volume Vx of a cut sample of the extruded foam plate is measured using Air Comparison Pycnometer Type-930 manufactured by Toshiba Beckmann Inc. At this time, a cut sample cut into the size of 25 mm×25 mm×20 mm and having no molded skin is placed in a sample cup for measurement. When the extruded foam plate is so thin that a cut sample having a thickness of 20 mm cannot be cut off therefrom, the measurement may be conducted using, for example, two cut samples having a size of 25 mm×25 mm×10 mm together. The closed cell content S (%) is calculated by the formula (7):

S(%)=(Vx−W/ρ)×100/(Va−W/ρ) (7)

wherein

Vx: True volume (cm³) of the cut sample(s) measured by the above method, which corresponds to a sum of a volume of the resin constituting the cut sample(s) and a total volume of all the closed cells in the cut sample(s);

Va: Apparent volume (cm³) of the cut sample(s) used for the measurement, which is calculated from the outer dimension thereof;

W: Weight (g) of the cut sample(s) used for the measurement; and

ρ: Density (g/cm³) of the resin constituting the extruded foam plate.

Similar measurement is carried out on three different samples and an average is calculated.

The following examples will further illustrate the present invention.

### EXAMPLES 1, 3, AND 4, COMPARATIVE EXAMPLES 1 AND 2

The ingredients used were 100 parts by weight of polystyrene (G330C made by Toyo Styrene Co.), 16.7 parts by weight of a talc master batch (a master batch composed of 69% by weight of the same polystyrene as above, 30% by weight of talc (High Filler #12, made by Matsumura Sangyo Co., Ltd.) and 1% by weight of zinc stearate) as a nucleating agent, a mixture of 3 parts by weight of hexabromocyclododecane and a small amount of stabilizer as a flame retardant, and a blowing agent prepared by mixing isobutane, methyl chloride, dimethyl ether and carbon dioxide in a proportion shown in Table 1-1 or Table 1-2 in an amount (represented as an amount (mol/kg) of the blowing agent per 1 kg of polystyrene) shown in Table 1-1 or Table 1-2.

As the extruder, an extruder having a diameter of 65 mm (which will be hereinafter referred to as “first extruder”), an extruder having a diameter of 95 mm (which will be hereinafter referred to as “second extruder”) and an extruder having a diameter of 150 mm (which will be hereinafter referred to as “third extruder”) connected in series were used. The blowing agent was injected into the molten resin at a position near the end of the first extruder.

A die lip having a resin discharge port having a width of 115 mm and a lip gap of 1.5 mm (rectangular cross-section) at an end thereof was used. At the end of the die lip was attached a passage which was defined by upper, lower, right and left walls made of polytetrafuluoroethylene and in which the distance between the upper and lower walls was once enlarged and then narrowed from the entrance toward the exit, as shown in FIG. 1.

The height (h: mm) and width (b: mm) of that part of the passage at which the cross-sectional area of the passage is smallest is shown in Table 1-1 and Table 1-2. The thickness (T: mm) and width (W: mm) of the extruded foam plate was adjusted such that W/b, T/h, and (W/b)/(T/h) had a value shown in Table 1-1 or Table 1-2.

The shaping device was constructed by upper and lower parallel plate made of polytetrafluoroethyrene and the gap therebetween was set as shown in Table 1-1 or Table 1-2. The shaping device was attached to the passage as shown in FIG. 1.

The ingredients including the polystyrene-based resin were kneaded in the first extruder at 220° C. The blowing agent was injected into the kneaded mixture at a position near the end of the first kneader to obtain a foamable molten composition which was subsequently passed successively through the second and third extruders. During the passage through the second and third extruders, the foamable molten composition was gradually cooled so that the temperature of the foamable molten composition at a position between the third extruder and the die was as shown in Table 1-1 or Table 1-2 (indicated as “foaming temperature”). The foamable molten composition was then extruded through the die lip at an extrusion rate shown in Table 1-1 or Table 1-2 while maintaining the temperatures of the die and the die lip at 120° C. and 110° C., respectively. In this case, the pressure of the foamable molten composition in the die was 30 kgf/cm² in all examples and comparative examples other than Example 4 in which the pressure was 35 kgf/cm².

The foamable molten composition extruded from the die lip was compressed and allowed to foam during its passage through the passage and then allowed to fill in the shaping device to shape it into a plate shape, thereby obtaining an extruded foam plate. The withdrawal rate at that time is shown in Table 1-1 or Table 1-2.

The apparent density, thickness, closed cell content, cell diameter in the thickness direction of the plate, cell strain rate, thermal conductivity, flammability, and residual amount of blowing agents of the thus obtained extruded foam plate are summarized in Table 2-1 or Table 2-2.

### EXAMPLE 2

An extruded foam plate was produced in the same manner as in Example 1 except that the amount of the talc master batch was changed to 8.3 parts by weight. The apparent density, thickness, closed cell content, average cell diameter in the thickness direction of the plate, cell strain rate, thermal conductivity, flammability, and residual amount of blowing agents of the thus obtained extruded foam plate are summarized in Table 2-1.

### COMPARATIVE EXAMPLE 3

An extruded foam plate was produced in the same manner as in Example 1 except that the amount of the talc master batch was changed to 1.7 parts by weight. The apparent density, thickness, closed cell content, average cell diameter in the thickness direction of the plate, cell strain rate, thermal conductivity, flammability, and residual amount of blowing agents of the thus obtained extruded foam plate are summarized in Table 2-2.

### COMPARATIVE EXAMPLE 4

An extruded foam plate was produced in the same manner as in Example 1 except that the passage in which the distance between the upper and lower walls was once enlarged and then narrowed from the entrance toward the exit was changed to a passage in which the distance between the upper and lower walls was enlarged gradually and linearly from the entrance toward the exit. The apparent density, thickness, closed cell content, average cell diameter in the thickness direction, cell strain rate, thermal conductivity, flammability and residual amount of blowing agent are summarized in Table 2-2.

TABLE 1-1
Production Conditions

| | | Ex. | Ex. | Ex. | Ex. |
|---|---|---|---|---|---|
| | | 1 | 2 | 3 | 4 |
| Amount of | Isobutane | 0.628 | 0.628 | 0.636 | 0.636 |
| blowing | Methyl chloride | 0.412 | 0.412 | 0 | 0 |
| agents | Dimethyl ether | 0 | 0 | 0.424 | 0.318 |
| (mol/kg) | Carbon dioxide | 0 | 0 | 0 | 0.106 |
| | Total | 1.040 | 1.040 | 1.060 | 1.060 |
| Mixing | Isobutane | 60.4 | 60.4 | 60.0 | 60.0 |
| proportion | Methyl chloride | 39.6 | 39.6 | 0 | 0 |
| of blowing | Dimethyl ether | 0 | 0 | 40.0 | 30.0 |
| agents | Carbon dioxide | 0 | 0 | 0 | 10.0 |
| (mol %) | | | | | |
| Dimension of | Height h | 18 | 18 | 18 | 18 |
| part of passage | Width b | 170 | 170 | 170 | 170 |
| at which cross- | | | | | |
| sectional area | | | | | |
| is smallest | | | | | |
| (mm) | | | | | |
| Dimension of | Thickness T | 25 | 25 | 25 | 25 |
| extruded foam | Width W | 240 | 240 | 240 | 240 |
| plate (mm) | | | | | |

| | | | | |
|---|---|---|---|---|
| W/b | 1.41 | 1.41 | 1.41 | 1.41 |
| T/h | 1.39 | 1.39 | 1.39 | 1.39 |
| (W/b)/(T/h) | 1.01 | 1.01 | 1.01 | 1.01 |
| Distance between upper and | 25 | 25 | 25 | 25 |
| lower parallel plates of | | | | |
| shaping device (mm) | | | | |
| Foaming temperature (° C.) | 125 | 125 | 125 | 125 |
| Extrusion rate (kg/hr) | 50 | 50 | 50 | 50 |
| Withdrawal rate (m/min) | 3.2 | 3.2 | 3.2 | 3.2 |

TABLE 1-2
Production Conditions

| | | Comp. | Comp. | Comp. | Comp. |
|---|---|---|---|---|---|
| | | Ex. 1 | Ex. 2 | Ex. 3 | Ex. 4 |
| Amount of | Isobutane | 0.879 | 0.313 | 0.628 | 0.628 |
| blowing | Methyl chloride | 0.376 | 0.730 | 0.412 | 0.412 |
| agents | Dimethyl ether | 0 | 0 | 0 | 0 |
| (mol/kg) | Carbon dioxide | 0 | 0 | 0 | 0 |
| | Total | 1.255 | 1.043 | 1.040 | 1.040 |
| Mixing | Isobutane | 70.0 | 30.0 | 60.4 | 60.4 |
| proportion | Methyl chloride | 30.0 | 70.0 | 39.6 | 39.6 |
| of blowing | Dimethyl ether | 0 | 0 | 0 | 0 |
| agents | Carbon dioxide | 0 | 0 | 0 | 0 |
| (mol %) | | | | | |
| Dimension of | Height h | 18 | 18 | 18 | — |
| part of passage | Width b | 170 | 170 | 170 | — |
| at which cross- | | | | | |
| sectional are is | | | | | |
| smallest (mm) | | | | | |
| Dimension of | Thickness T | 25 | 25 | 25 | 25 |
| extruded foam | Width W | 240 | 240 | 250 | 250 |
| plate (mm) | | | | | |

| | | | | |
|---|---|---|---|---|
| W/b | 1.41 | 1.41 | 1.47 | — |
| T/h | 1.39 | 1.39 | 1.39 | — |
| (W/b)/(T/h) | 1.01 | 1.01 | 1.06 | — |
| Distance between upper and | 25 | 25 | 25 | 25 |
| lower parallel plates of | | | | |
| shaping device (mm) | | | | |
| Foaming temperature (° C.) | 125 | 125 | 125 | 125 |
| Extrusion rate (kg/hr) | 50 | 50 | 50 | 50 |
| Withdrawal rate (m/min) | 3.2 | 3.2 | 3.2 | 3.2 |

TABLE 2-1
Test Results

| | | Ex. 1 | Ex. 2 | Ex. 3 | Ex. 4 |
|---|---|---|---|---|---|
| Apparent | | 41.5 | 39.2 | 42.7 | 41.1 |
| density (kg/m³) | | | | | |
| Thickness (mm) | | 25 | 25 | 25 | 25 |
| Average cell diameter | | 0.09 | 0.13 | 0.12 | 0.12 |
| in thickness | | | | | |
| direction (mm) | | | | | |
| Cell strain rate | | 0.99 | 0.91 | 1.01 | 0.98 |
| Closed cell content | | 94 | 94 | 94 | 95 |
| (%) | | | | | |
| Thermal | *1 | 0.027 | 0.027 | 0.027 | 0.027 |
| conductivity | *2 | 0.027 | 0.027 | 0.027 | 0.027 |
| (W/m · K) | | | | | |
| Flammability | *1 | 1.8 | 2.2 | 2.3 | 1.8 |
| (sec) | *2 | 1.9 | 1.9 | 2.1 | 1.8 |
| Residual | Isobutane | 0.61 | 0.62 | 0.61 | 0.61 |
| amount of | Methyl | Not | Not | 0 | 0 |
| blowing | chloride | greater | greater | | |
| agent | | than | than | | |
| (mol/kg) | | 0.02 | 0.02 | | |
| *1 | Dimethyl | 0 | 0 | Not | Not |
| | ether | | | greater | greater |
| | | | | than | than |
| | | | | 0.01 | 0.01 |

| | | | | |
|---|---|---|---|---|
| Residual amount of | 0.60 | 0.61 | 0.60 | 0.60 |
| isobutane (mol/kg) *2 | | | | |

*1: Measured 4 weeks after the production.
*2: Measured 3 months after the production.
*3: Burned beyond the burning limit line.

TABLE 2-2
Test Results

| | | Comp. | Comp. | Comp. | Comp. |
|---|---|---|---|---|---|
| | | Ex. 1 | Ex. 2 | Ex. 3 | Ex. 4 |
| Apparent | | 35.4 | 40.7 | 39.6 | 41.0 |
| density(kg/m³) | | | | | |
| Thickness (mm) | | 25 | 25 | 25 | 25 |
| Average cell diameter | | 0.12 | 0.11 | 0.33 | 0.18 |
| in thickness | | | | | |
| direction (mm) | | | | | |
| Cell strain rate | | 0.90 | 0.96 | 0.98 | 1.52 |
| Closed cell content (%) | | 93 | 94 | 94 | 93 |
| Thermal | *1 | 0.026 | 0.029 | 0.029 | 0.029 |
| Conductivity | *2 | 0.027 | 0.030 | 0.030 | 0.029 |
| (W/m · K) | | | | | |
| Flammability | *1 | 6.5 | 1.5 | 2.0 | 2.1 |
| (sec) | | *3 | | | |
| | *2 | 5.8 | 1.4 | 2.0 | 2.1 |
| | | *3 | | | |
| Residual | Isobutane | 0.84 | 0.29 | 0.60 | 0.61 |
| amount of | Methyl | Not | Not | Not | Not |
| blowing | chloride | greater | greater | greater | greater |
| agent | | than | than | than | than |
| (mol/kg) *1 | | 0.02 | 0.02 | 0.02 | 0.02 |
| | Dimethyl | 0 | 0 | 0 | 0 |
| | ether | | | | |

| | | | | |
|---|---|---|---|---|
| Residual amount of | 0.82 | 0.28 | 0.60 | 0.60 |
| isobutane (mol/kg) *2 | | | | |

*1 Measured 4 weeks after the production.
*2 Measured 3 months after the production.
*3 Burned beyond the burning limit line.

The apparent density, shown in Table 2-1 and Table 2-2, was measured according to JIS K7222-1985.

The thickness, shown in Table 2-1 and Table 2-2, is the arithmetic mean of the values measured at positions at which the width of the extruded foam plate is divided into equal quarters.

The average cell diameter in the thickness direction and the cell strain rate, shown in Table 2-1 and Table 2-2, were measured according to the methods mentioned before.

The closed cell content, shown in Table 2-1 and Table 2-2, was measured on a 25 mm×25 mm×20 mm cut sample cut off from the extruded foam plate and having no molded skin according to the method mentioned before.

The thermal conductivity, shown in Table 2-1 and Table 2-2, was measured on two classes of sample pieces cut off from the extruded foam plate 4 weeks and three months, respectively, after the production. Each sample piece had a length of 20 cm, a width of 20 cm and a thickness of the extruded foam plate. The measurement was carried out by the plate type heat flow meter method (twin-plate type heat flow meter, average temperature: 20° C.) described in JIS A1412-1994 according to an instruction in Section 4.7 of JIS A9511-1995 using a thermal conductivity tester AUTO A Model HC-73 (manufactured by Eko Instruments Trading Co., Ltd.).

The flammability, shown in Table 2-1 and Table 2-2, was measured according to Measuring Method A described in Section 4.13.1 of JIS A9511-1995.

The residual amount of blowing agent (content of blowing agent per 1 kg of the foam plate), shown in Table 2-1 and Table 2-2, was measured according to the method mentioned before, using cyclopentane as an internal standard substance, with Shimadzu Gas Chromatograph GC-14B manufactured by Shimadzu Corporation.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

What is claimed is:

1. An extruded, polystyrene-based resin foam plate produced by extruding a foamable molten composition containing a polystyrene-based resin and a blowing agent consisting of (a) isobutane and (b) a blowing agent component other than isobutane, chlorofluorocarbons and fluorocarbons from a high pressure zone into a lower pressure zone, said extruded foam plate
having a thickness of at least 10 mm and an apparent density of 25-60 kg/m³,
containing residual isobutane in an amount of 0.45-0.80 mol per 1 kg thereof,
having cells having an average diameter in the thickness direction thereof of 0.05-0.18 mm and a cell strain rate of 0.7-1.2, wherein the cell strain rate is obtained by dividing the average diameter in the thickness direction of the extruded foam plate by the average diameter in the horizontal direction of the extruded foam plate,
meeting the flammability standard on extruded polystyrene foam insulation plates as defined in JIS A9511-1995, and
having a thermal conductivity of not greater than 0.028 W/m·K.

2. The foam plate as claimed in claim 1, wherein said residual amount of isobutane is greater than 0.56 mol but not greater than 0.76 mol per 1 kg thereof.

3. The foam plate as claimed in claim 1, and containing talc in an amount of 1-10 parts by weight per 100 parts of said polystyrene-based resin.

4. The foam plate as claimed in claim 1, and containing hexabromocycrododecane in an amount of at least 2 parts by weight per 100 parts of said polystyrene-based resin.

5. The foam plate as claimed in claim 1, and having an apparent density of 36-60 kg/m³.

6. A method for the production of an extruded polystyrene-based resin foam plate, comprising the steps of;
(a) kneading a raw material composition comprising a molten polystyrene-based resin, a blowing agent consisting of 90-50 mol % of isobutane and a balance of a blowing agent component other than isobutane, chlorofluorocarbons and fluorocarbons, and a flame retardant in an extruder to obtain a foamable molten composition;
(b) continuously extruding said foamable molten composition from a high pressure zone into a lower pressure zone through a die;
(c) passing said extruded foamable molten composition, while it is foaming, through a passage which is defined by upper, lower, right and left walls and which is connected to said die, wherein the distance between said upper and lower walls is once enlarged and then narrowed from the entrance toward the exit to compress said foamable molten composition during its passage through said passage; and
(d) then passing said compressed foamable molten composition through a shaping device, in which said compressed foamable molten composition is allowed to expand in at least thickness and width directions thereof with at least the expansion in the thickness direction being restrained by said shaping device, thereby to obtain the extruded foam plate,
wherein said passage meeting the following conditions (1) to (3):
W/b≧1.08 (1)
T/h≧1.20 (2)
(W/b)/(T/h)≧0.90 (3)
wherein T and W are the thickness (mm) and width (mm), respectively, of the extruded polystyrene-based foam plate obtained, and h and b are the height h (mm) and width b (mm), respectively, of that part of said passage at which the cross-sectional area of said passage is smallest in the downstream of that part of said passage at which the cross-sectional area of said passage is largest.

7. A method as claimed in claim 6, wherein said blowing agent consists of 90-50 mol % of isobutane and 10-50 mol & of at least one blowing agent component selected from the group consisting of alkyl chlorides, carbon dioxide, dimethyl ether, diethyl ether and methyl ethyl ether.
